(19) United States
(12) Patent Application Publication
(10) Pub. No.: US 2020/0369931 A1
(43) Pub. Date: Nov. 26, 2020

(54) PLASTIC FILM ADHESIVE AGENT

(71) Applicant: Meng Sin Material Co., LTD, Pingtung County (TW)

(72) Inventors: Feng-Chuan Huang, Kaohsiung City (TW); Meng-Tsung Kao, Kaohsiung City (TW)

(73) Assignee: Meng Sin Material Co., LTD, Pingtung County (TW)

(21) Appl. No.: 16/536,527

(22) Filed: Aug. 9, 2019

(30) Foreign Application Priority Data
May 21, 2019 (TW) 108117503

(51) Int. Cl. C09J 167/00; C09J 11/08; C09J 11/06

(52) U.S. Cl. CPC C09J 167/00; C09J 11/06; C09J 11/08

(57) ABSTRACT

Disclosed is a plastic film adhesive agent, comprising 50˜95 percentage by weight of an organic polymer polyester resin; 0.1˜30 percentage by weight of an isocyanate resin; 0.1˜15 percentage by weight of an adhesion promoter; 1.0˜30 percentage by weight of a first diluent; at most 15 percentage by weight of a second diluent; at most 5 percentage by weight of a catalyst; at most 5.5 percentage by weight of a modifier; and at most 10 percentage by weight of a stabilizer, which can directly adhere a polypropylene material to a metal surface.

### FIELD OF THE INVENTION

The present invention relates to a plastic film adhesive agent, and more particularly to an adhesive agent which adheres plastic film and metal.

### BACKGROUND OF THE INVENTION

As a metal packaging material, the technique of applying surface treatment to metal, especially the technique of applying resin coating film to a metal surface, which is suitable for food packaging materials due to advantages of high airtightness, high hardness, high light-blocking property, and corrosion resistance, has been gradually valued in recent years.

Polypropylene (PP), among the resin, is considered to be suitable for use in metal coating due to its high mechanical strength, low density, high temperature resistance, resistance to various organic solvents and acid-base corrosion.

However, polypropylene molecules have extremely low polarity and thus the polypropylene is difficult to be adhered to a metal surface through adhesive agents. In view of this problem, there are several known methods such as applying a material having affinity to both polypropylene and adhesive agent through the bonding surface, roughening the surface of the film in advance and bonding the structure of the polypropylene material to the surface of the substrate by heating.

It is necessary to add additional processing steps in the process in the above methods which are disadvantageous to the processing cost.

### SUMMARY OF THE INVENTION

Accordingly, it is an object of the present invention to provide a plastic film adhesive agent which can be used to directly adhere a polypropylene material to a metal surface.

To achieve the above object, the present invention provides a plastic film adhesive agent, comprising 50˜95 percentage by weight of an organic polymer polyester resin; 0.1˜30 percentage by weight of an isocyanate resin; 0.1˜15 percentage by weight of an adhesion promoter; 1.0˜30 percentage by weight of a first diluent; at most 15 percentage by weight of a second diluent; at most 5 percentage by weight of a catalyst; at most 5.5 percentage by weight of a modifier; and at most 10 percentage by weight of a stabilizer.

According to an embodiment of the present invention, the adhesion promoter includes epoxy resin adhesive.

According to an embodiment of the present invention, the first diluent includes benzene solvent.

According to an embodiment of the present invention, the catalyst includes sulfonic acid catalyst or tin-containing catalyst.

According to an embodiment of the present invention, the modifier includes butadiene, styrene or acrylic monomer,

According to an embodiment of the present invention, the stabilizer includes calcium stearate stabilizer.

According to an embodiment of the present invention, the second diluent includes ether solvent,

By way of the technical means adopted by the present invention, the plastic film adhesive agent can directly and firmly adhere a polypropylene material to a metal surface.

### BRIEF DESCRIPTION OF THE DRAWINGS

FIG. 1 shows the result of adhesion test of the plastic film adhesive agent according to one embodiment of the present invention;

FIG. 2 shows the result of adhesion test of general adhesive agent.

### DETAILED DESCRIPTION OF THE PREFERRED EMBODIMENTS

The following description is for describing preferable embodiments of the present invention, but not for limiting the present invention.

The plastic film adhesive agent according to an embodiment of the present invention, reference to its whole amount, is made of adding and stirring 0.1˜30 percentage by weight of isocyanate resin, 0.1˜15 percentage by weight of adhesion promoter, 1.0˜30 percentage by weight of the first diluent, at most 15 percentage by weight of the second diluent, at most 5 percentage by weight of catalyst, at most 5.5 percentage by weight of modifier and at most 10 percentage by weight of stabilizer into 50˜95 percentage by weight of organic polymer polyester resin.

In the plastic film adhesive agent according to an embodiment of the present invention, the adhesion promoter includes epoxy resin adhesive; the first diluent includes benzene solvent; the catalyst includes sulfonic acid catalyst or tin-containing catalyst; the modifier includes butadiene, styrene or acrylic monomer; the stabilizer includes calcium stearate stabilizer; the second diluent includes ether solvent.

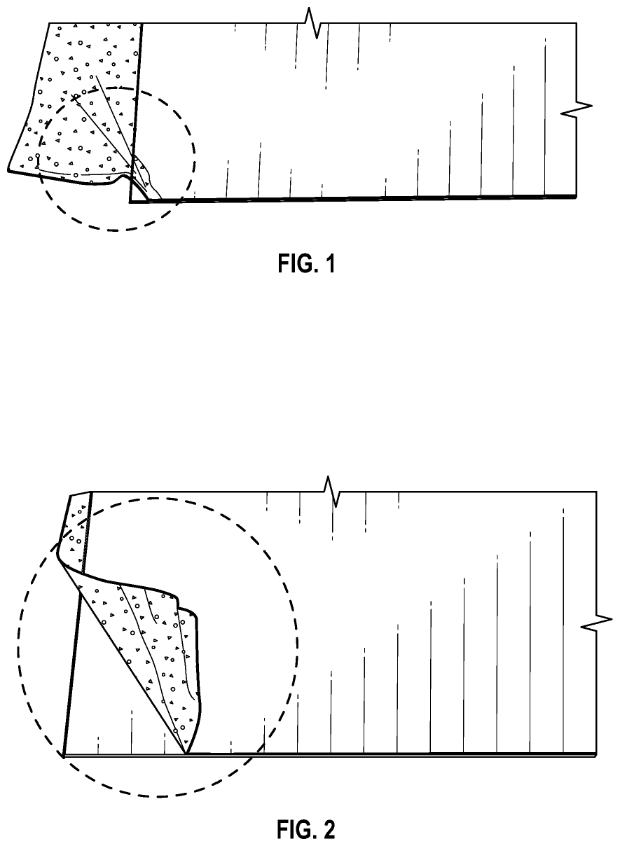

FIG. 1 and FIG. 2 show the result of adhesion test of the plastic film adhesive agent and a commercial general adhesive agent. In the adhesion test, the plastic film adhesive agent of the first embodiment of the present invention and a commercial general adhesive agent are respectively applied to individual metal sheets, and then the polypropylene material is adhered to the metal sheet surface which coated with adhesive agent; after a fixed period of time, pull the polypropylene material along the edge of the sheet metal in the opposite direction of the sheet metal.

As shown in FIG. 1, when using the plastic film adhesive agent according to an embodiment of the present invention, after the polypropylene material is adhered to the metal sheet, the bonded polypropylene material cannot be separated from the metal sheet even if the polypropylene material is deformed or even broken.

As shown in FIG. 2, when it comes to using the commercial general adhesive agent, the polypropylene material cannot be adhered to the metal sheet, and the polypropylene material is peeled off from the metal sheet easily.

As the result, the plastic film adhesive agent of present invention can firmly adhere a polypropylene material to a metal surface.

The above is for describing preferable embodiments of the present invention, a person skilled in the art may make various modifications to the present invention. Those modifications still fall within the spirit and scope defined by the appended claims.

What is claimed is:

1. A plastic film adhesive agent, comprising:
50˜95 percentage by weight of an organic polymer polyester resin;
0.1˜30 percentage by weight of an isocyanate resin;
0.1˜15 percentage by weight of an adhesion promoter;
1.0˜30 percentage by weight of a first diluent;
at most 15 percentage by weight of a second diluent;
at most 5 percentage by weight of a catalyst;
at most 5.5 percentage by weight of a modifier; and
at most 10 percentage by weight of a stabilizer.

2. The plastic film adhesive agent as claimed in claim 1, wherein the adhesion promoter includes epoxy resin adhesive.

3. The plastic film adhesive agent as claimed in claim 1, wherein the first diluent includes benzene solvent.

4. The plastic film adhesive agent as claimed in claim 1, wherein the catalyst includes sulfonic acid catalyst or tin-containing catalyst.

5. The plastic film adhesive agent as claimed in claim. 1, wherein the modifier includes butadiene, styrene or acrylic monomer,

6. The plastic film adhesive agent as claimed in claim 1, wherein the stabilizer includes calcium stearate stabilizer.

7. The plastic film adhesive agent as claimed in claim 1, wherein the second diluent includes ether solvent.
